(19) United States
(12) Patent Application Publication
(10) Pub. No.: US 2026/0292953 A1
(43) Pub. Date: Sep. 24, 2026

(54) A TAPPED LINEAR LED DRIVING ARRANGEMENT

(71) Applicant: SIGNIFY HOLDING B.V., EINDHOVEN (NL)

(72) Inventors: KARNEKUMAR ARULANDU, BREDA (NL); HAIMIN TAO, EINDHOVEN (NL)

(21) Appl. No.: 19/471,787

(22) PCT Filed: Mar. 28, 2024
(86) PCT No.: PCT/EP2024/058729

§ 371 Date: Oct. 2, 2025

(30) Foreign Application Priority Data
Apr. 7, 2023 (EP) 23167187.6

(51) Int. Cl. H05B 45/48

(52) U.S. Cl. CPC H05B 45/48

(57) ABSTRACT

A tapped linear LED driving arrangement. The arrangement comprises a first LED module, a charge storage device and at least one other LED module. The first LED module comprises an LED set and a current controller connected in series. Each other LED module comprises an LED set and a switch arrangement connected in parallel. The charge storage device is connected in parallel to the first LED module. The current controller controls the current flow through the LED set of the first LED module, to facilitate a response to the bypassing of the LED set of any other LED module by their respective switch arrangements.

### FIELD OF THE INVENTION

The present invention relates to the field of LED modules, and in particular to LED driving arrangements that make use of tapped linear drivers.

### BACKGROUND OF THE INVENTION

The increasing use of artificial light is causing a greater demand for LED devices, e.g., for use in automobile applications.

An existing form of LED driving arrangements comprises a tapped linear driver. In general, such drivers comprise a string of serially connected light emitting diodes (LED). It is common for the cathode end of each LED (except one LED in the string) is controllably coupled to the anode end of the LED or to a ground or reference voltage by a respective switch, so as to control a current flow through subsequent LEDs in the string. The current flow through each respective LED in the string is controlled responsive to an available power for driving the string. International Patent Application No. WO 2012/168827 A2 provides one example of an LED module with a tapped linear driver.

U.S. Pat. No. 8,330,390 B2 provides another example that also makes use of an charge storage device, in the form of a capacitor. The charge storage device is selectively connected to the LED string when a main power source is below a predetermined value, otherwise the charge storage device is charged by the main power source.

There is an ongoing desire to improve the performance of LED driving arrangements, particularly those with tapped linear drivers.

### SUMMARY OF THE INVENTION

The invention is defined by the claims.

According to examples in accordance with an aspect of the invention, there is provided a tapped linear LED driver arrangement comprising: a first input terminal and a second input terminal for receiving an input voltage from an external power supply; a first LED module comprising a first LED set, comprising one or more LEDs connected in series, and a first current controller connected in series to the first LED set; a second LED module connected in series with the first LED module and comprising a second LED set, comprising one or more LEDs connected in series, and a first switch arrangement connected in parallel to the second LED set; and a charge storage device connected in parallel to the first LED module.

The first LED module and the second LED module are connected in series between the first and second input terminals.

The first current controller is configured to: responsive to the amplitude of the input voltage rising above a first threshold, reduce or prevent a current flow through the first LED set such that current, from the input terminal, flows through the charge storage device to the second LED module; and responsive to the amplitude of the input voltage falling below the first threshold, increase a current flow through the first LED set such that current flows from the charge storage device through the first LED set.

The first switch arrangement is configured to: responsive to the amplitude of the input voltage falling below a second threshold, bypass the second LED set to thereby prevent the second LED set conducting current; and responsive to the amplitude of the input voltage rising above the second threshold, prevent bypassing of the second LED set to thereby permit the second LED set to conduct current, wherein the first current controller is configured to control a maximum current flow through the first LED set such that when the input voltage is below the first threshold, the first LED set emits a same or nearly same amount of light as emitted by the second LED set when the input voltage is above the second threshold.

The proposed LED driver arrangement provides a new form of tapped linear driver with a different form of LED module. In particular, a charge storage device is connected in parallel to (only) one of the LED modules and a current controller is used to control current flow from the charge storage device through the LED set of said LED module. This facilitates the emission of light even in the absence of sufficient power from the external power supply with improved control of current flow in the LED driver arrangement. In addition, over time, a more homogeneous light may be generated by the tapped linear LED driver arrangement because the first LED module and the second LED module provide approximately a similar light output over time.

Proposed approaches allow for the current through a first LED set to be controlled, e.g., to respond to changes in current flow through any other LED sets resulting from a standard operation of a tapped linear driver. This allows for easy compensation of any reduction in light emission that would otherwise result from other LED sets being bypassed (as would conventionally happen in a TLD).

Thus, the proposed mechanism provides a system by which a current controller is able to independently distribute a total current provided via the external power supply between a charging current for a charge storage device or to power an LED set. This facilitates the ability to compensate for any output power fluctuation of the LED driver arrangement, e.g., to achieve a constant or near-constant light output for a pulsating input voltage.

The second threshold may be less than or equal to the first threshold. In this way, the first LED set is able to immediately act upon the second LED set stopping the conduction of current. This ensures that the LED driver arrangement will continually output light (when powered by the external power supply).

The second threshold may be equal to the sum of the forward voltage of the first LED set and the forward voltage of the second LED set.

The first current controller may comprise a controllable current source.

The arrangement may further comprise a controller configured to control the operation of the first current controller and the first switch arrangement.

The first LED set may comprise a first LED and a second LED connected in series. The first LED set may also comprise an LED bypass arrangement connected in parallel to the second LED, the LED bypass arrangement being configured to: responsive to the amplitude of a voltage across the first LED or the voltage across the charge storage device falling below a first LED threshold, bypass the second LED to thereby prevent the second LED conducting current; and responsive to the amplitude of a voltage across the first LED or the voltage across the charge storage device rising above the first LED threshold, prevent bypassing of the second LED to thereby allow the second LED to conduct current.

The arrangement may further comprise a second current source controller connected in series with the second LED module for controlling a maximum current flow through the first and second LED modules. This approach allows for the current through the second LED module to be controlled such that the total light output by the drive arrangement can be maintained or held at a consistent level.

The arrangement may further comprise a third LED module connected in series with the second LED module and comprising: a third LED set comprising one or more LEDs connected in series; and a second switch arrangement connected in parallel to the third LED set, the second switch arrangement being configured to: responsive to the amplitude of the input voltage falling below a third threshold, bypass the third LED set to thereby prevent the third LED set conducting current; and responsive to the amplitude of the input voltage rising above the third threshold, prevent bypassing of the third LED set to thereby permit the third LED set to conduct current. The third threshold is different to the second threshold.

In some examples, the first current controller is configured to: responsive to the amplitude of the input voltage falling below a fourth threshold, increase a current flow through the first LED set; responsive to the amplitude of the input rising above the fourth threshold, reduce the current flow through the first LED set.

The fourth threshold is less than the first threshold.

The first current controller may be further configured such that the current flow through the first LED set is greater when the amplitude of the input voltage is between the fourth threshold and the first threshold than when the amplitude of the input voltage is above the first threshold.

The fourth threshold may be greater than or equal to the third threshold.

There is also proposed an LED driving system comprising any herein disclosed tapped linear LED drive arrangement; and a rectifier, connected to the first and second input terminals, configured to rectify a mains power supply to produce the input voltage for the first and second input terminals.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a proposed LED driving system;

FIG. 2 illustrates waveforms in a proposed LED driving system;

FIG. 3 illustrates another proposed LED driving system;

FIG. 4 illustrates waveforms in the other proposed LED driving system; and

FIG. 5 illustrates yet another proposed LED driving system.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a tapped linear LED driving arrangement. The arrangement comprises a first LED module, a charge storage device and at least one other LED module. The first LED module comprises an LED set and a current controller connected in series. Each other LED module comprises an LED set and a switch arrangement connected in parallel. The charge storage device is connected in parallel to the first LED module. The current controller controls the current flow through the LED set of the first LED module, to facilitate a response to the bypassing of the LED set of any other LED module by their respective switch arrangements.

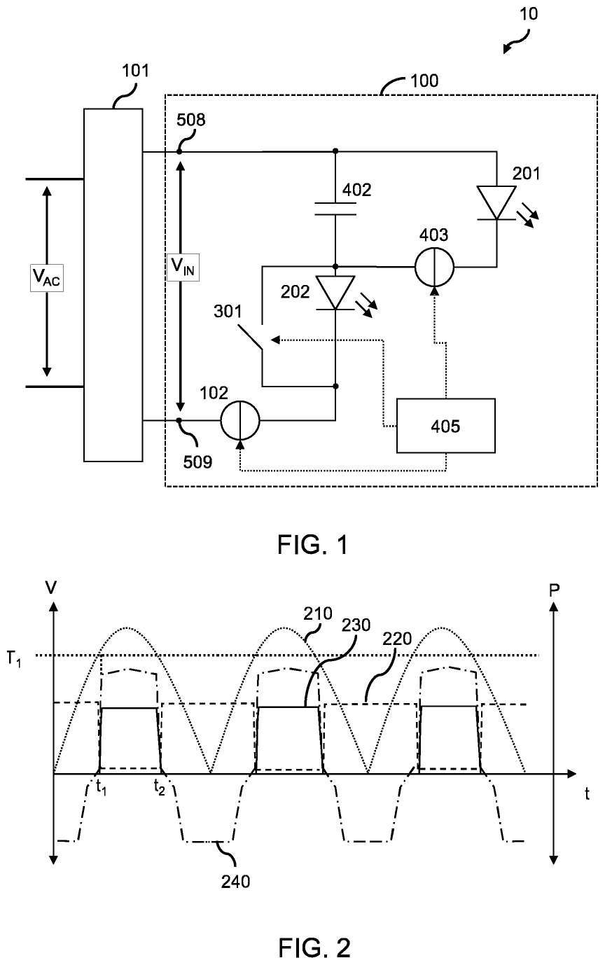

FIG. 1 illustrates an LED driving system 10 comprising a tapped linear LED driving arrangement 100 according to an embodiment.

The LED driving system 10 also comprises a rectifier 101 configured to rectify a mains power supply V_{AC}, i.e., an alternating power supply, to produce an input voltage V_{IN} for the tapped linear LED driving arrangement. Suitable examples of rectifiers are well known in the art, and include bridge rectifiers. The input voltage V_{IN} is therefore a rectified version of a sinusoidal signal, i.e., a pulsating signal that pulsates at twice the frequency of the mains power supply.

The tapped linear LED driving arrangement 100 comprises a first input terminal 508 and a second input terminal 509. The input terminals receive an/the input voltage V_{IN} from an external power supply, which in the illustrated example is the rectifier 101.

The tapped linear LED driving arrangement 100 also comprises a first LED module 201, 403, which is coupled to the first input terminal 508.

The first LED module comprises a first LED set 201 comprising one or more LEDs connected in series. In the illustrated example, the first LED set comprises only a single LED, but the skilled person will appreciate that this can be readily replaced by a series/parallel connection of two or more LEDs.

The first LED module also comprises a first current controller 403 connected in series with the first LED set 201. The first current controller 403 is thereby able to control a current through the first LED set.

The tapped linear LED driving arrangement 100 also comprises a second LED module 202, 301, which is connected in series with the first LED module. More particularly, the first and second LED modules are connected in series between the first input terminal 508 and the second input terminal 509.

The second LED module comprises a second LED set 202 (comprising one or more LEDs) and a first switch arrangement 301. The first switch arrangement is able to selectively bypass the second LED set. In the illustrated example, the second LED set 202 comprises only a single LED, but the skilled person will appreciate that this can be readily replaced by a series/parallel connection of two or more LEDs.

The tapped linear LED driving arrangement 100 also comprises a charge storage device 402, e.g., a capacitor, connected in parallel to the first LED module. Thus, the charge storage device 402 is similarly connected in series with the second LED module.

The operation of the first current control 403 and the first switch arrangement 301 may be performed/controlled by a controller 405. The controller 405 may be configured to receive a signal (not shown) representing a magnitude of the input voltage and/or other feedback signals for controlling the current flow (e.g., a signal representing a magnitude of the current through the first LED set and/or the second LED set).

The first current controller 403 is configured to control the current flow through the first LED set 201 responsive to the amplitude of the input voltage V_{IN}. In this way, as a direct result of Kirchoff's current law, the first current controller 403 is able to control the current flow to/through the energy storage device 402, i.e., the charging current.

More particularly, the first current controller 403 is configured to control whether or not the first LED set 201 draws power away from the charge storage device 402 or prevents the first LED set 201 from drawing such power away such that the charge storage device charges (and causes current to flow through to the second LED module 202, 301).

The first current control 403 is configured to, responsive to the amplitude of the input voltage rising above a first threshold, reduce or prevent a current flow through the first LED set 201 such that (at least some) current, from the input terminal 508, flows through the charge storage device 402 to the second LED module 202, 301.

Thus, when the input voltage is sufficiently high, e.g., to drive the second LED set, the current through the first LED set is reduced and current can flow to the second LED module.

Similarly, the first current control 403 is configured to, responsive to the amplitude of the input voltage V_{IN} falling below the first threshold, increase a current flow through the first LED set such that current flows from the charge storage device through the first LED set.

In this way, the charge storage device 402 can be controlled by the current controller 403 to selectively drive or power the first LED set 201 based on whether or not the input voltage breaches a first threshold. The current controller thereby also controls a current flow to and through the charge storage device 402.

The first switch arrangement 301 is configured to selectively bypass the second LED set 202 responsive to whether or not the amplitude of the input voltage V_{IN} falls below a second threshold. When below the second threshold, the first switch arrangement 301 bypasses the second LED set (i.e., so that it no longer conducts current). When above the second threshold, the first switch arrangement 301 allows or permits the second LED set to conduct current.

In a simple example, the first and second thresholds are identical. Thus, only one of the first and second LED sets will conduct current at a time. This facilitates continual emission of light.

In other examples, the first and second thresholds are different, e.g., the first threshold is greater than or equal to the second threshold. This will cause the second LED set to begin conducting current (as the magnitude of the input voltage rises) before the current flow through the first LED set is reduced or prevented. Similarly, this will cause the first LED set to begin conducting current before the second LED set is bypassed (as the magnitude of the input voltage reduces). This can advantageously avoid any dips or drops in light output below some light threshold.

The first current controller 403 is able to effectively distribute current between the charge storage device 402 and the first LED set 201. This allows the first current controller 403 to compensate for any fluctuations or changes in the output power of any other LED set 202 (e.g., due to said LED set(s) being bypassed due to insufficient voltage), whilst still providing a mechanism for charging the charge storage device.

FIG. 2 illustrates waveforms representing a voltage (V) or power (P) of various signals against time (t). FIG. 2 is used to describe an approach for controlling the operation of the tapped linear LED driving arrangement 100 described in FIG. 1 according to the simple example (where the thresholds are identical).

A first waveform 210 illustrates the voltage provided to the input terminals 508, 509. A second waveform 220 illustrates the power drawn by the first LED set 201. A third waveform 230 illustrates the power drawn by the second LED set and a fourth waveform 240 illustrates the power storage by the charge storage device 402 over time.

FIG. 2 illustrates how when the voltage provided to the input terminals (i.e., an input voltage) reaches a threshold T₁ (and subsequently rises thereafter) at a first point in time t₁, the current flow through the first LED set is stopped, such that no or negligible power is drawn by the first LED set. The current thereafter flows through the charge storage device (charging the charge storage device as illustrated) and is provided to the second LED set.

When the voltage is above this threshold T₁, the first switch arrangement is controlled to prevent bypassing of the second LED set. Thus, the second LED set is able to conduct the current provided by the charge storage device. The second LED set thereby outputs light.

When the voltage is below the threshold T₁ (i.e., after a second point in time t₂) the first switch arrangement is controlled to bypass the second LED set to thereby prevent the second LED set conducting current.

Furthermore, when the voltage is below the threshold T₁ the current through the first LED set is increased, such that the first LED set draws power and emits light. The current through the first LED set is provided by the combination of the power at the input terminals 508, 509 (when sufficiently high) and power discharged from the charge storage device, as illustrated in FIG. 2.

As previously indicated, in this simple example, the first and second thresholds (for the input voltage) are the same. The value of the thresholds may be equal to a forward voltage of the second LED set (e.g., plus any headroom voltage required to drive any optional further components).

FIGS. 1 and 2 also illustrates an advantageous embodiment, in which the tapped linear LED driving arrangement 100 further comprises a second current source controller 102 connected in series with the second LED module 202, 301 for controlling a maximum current flow through the first and second LED modules.

In particular, the second current source controller 102 may be configured to control the maximum current flow through the second LED set (when it conducts current) such that the amount of light emitted by the second LED set does not exceed a certain threshold. Any excess power provided to the input terminals 508, 509 will be stored by the energy charge storage device 402.

Similarly, the first current source controller 403 may be configured to control the maximum current flow through the first LED set (when it conducts current), such that it emits the same or nearly the same amount of light as emitted by the second LED set when it conducts current. This advantageously provides a consistent or constant total light output by the tapped linear LED driving arrangement 100.

Put another way, the combination of the power drawn by the first LED set and the second LED set (assuming both LED sets contain similar components) is maintained through appropriate current control.

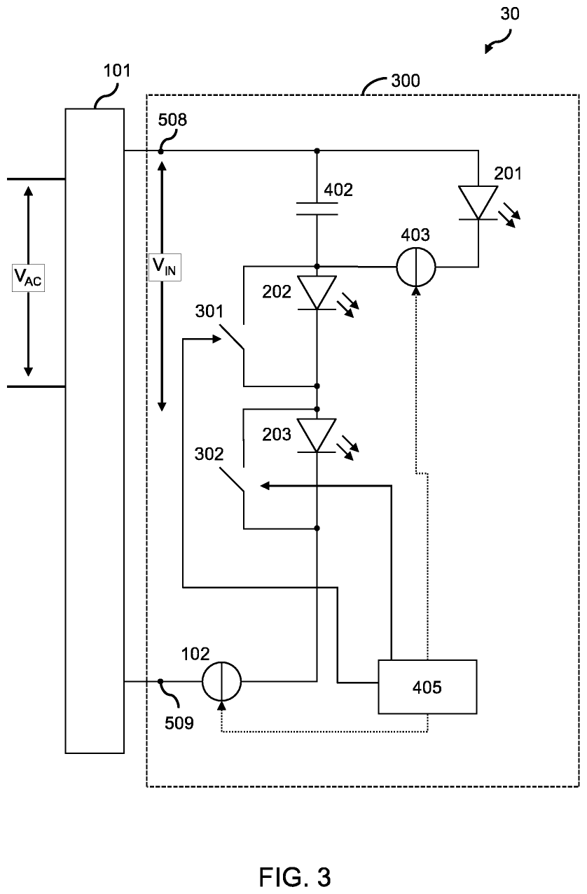

FIG. 3 illustrates a more advanced embodiment of an LED driving system 30, in which the tapped linear LED driver arrangement 300 further comprise a third LED module 203, 302 connected in series with the second LED module.

The third LED module comprises a third LED set 203 comprising one or more LEDs connected in series. The third LED module also comprises a second switch arrangement 302 connected in parallel to the third LED set.

The second switch arrangement 302 is configured to, responsive to the amplitude of the input voltage falling below a third threshold, bypass the third LED set 203 to thereby prevent the third LED set conducting current; and responsive to the amplitude of the input voltage rising above the third threshold, prevent bypassing of the third LED set to thereby permit the third LED set to conduct current.

The third threshold is different to the second threshold. This effectively allows the second and third LED sets to switch off at different points in the cycle of the input voltage. This follows standard tapped linear driver operations.

In some examples, the first current controller 403 is configured to responsive to the amplitude of the input voltage falling below a fourth threshold, increase a current flow through the first LED set; and responsive to the amplitude of the input rising above the fourth threshold, reduce the current flow through the first LED set.

The fourth threshold is less than the first threshold.

The first current controller 403 is also configured such that the current flow (i.e., the magnitude of the electrical current) through the first LED set 201 is greater when the amplitude of the input voltage is between the fourth threshold and the first threshold than when the amplitude of the input voltage is above the first threshold.

Thus, the current through the first LED set can be effectively stepped. When the magnitude of the input voltage is below the fourth threshold, the current is a first value. When the magnitude of the input voltage is between the fourth threshold and the first (higher) threshold, the current is at a second value, less than the first value. When the magnitude of the input voltage is above the first threshold, the current is at a third value, less than the second value (e.g., 0 or negligible).

This technique allows the current flow through the first LED set to be controlled to reflect the power drawn by the second and third LED sets.

Thus, the first threshold may control whether to allow or prevent the first LED set from conducting current; the second threshold may control whether or not the second LED set is bypassed; the third threshold may control whether or not the third LED set is bypassed; and the fourth threshold may control whether the first LED set conducts a first non-zero current or a second, different non-zero current.

The thresholds may be selected or configured such that the total current or power drawn by all LED sets is maintained to be effectively constant. This ensures or achieves a constant output of light (assuming that LED sets drawing the same current emit a same amount of light).

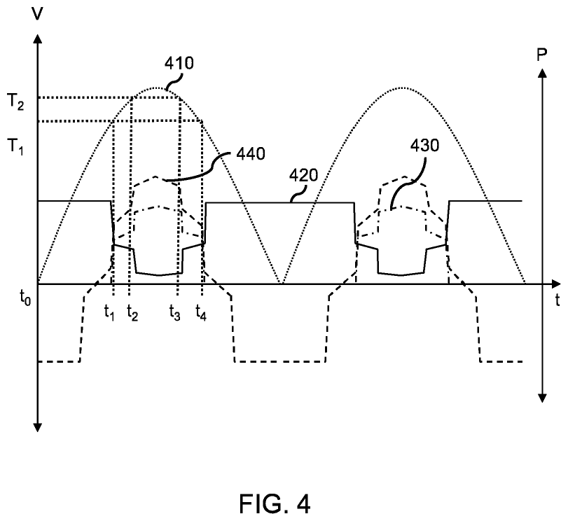

FIG. 4 illustrates waveforms representing a voltage (V) or power (P) of various signals against time (t). FIG. 4 is used to describe an approach for controlling the operation of the tapped linear LED driving arrangement 300 described in FIG. 3 according to an example.

A first waveform 410 illustrates the voltage provided to the input terminals 508, 509. A second waveform 420 illustrates the power drawn by the first LED set 201. A third waveform 430 illustrates the power drawn by the second 202 and third 203 LED sets and a fourth waveform 440 illustrates the power storage by the charge storage device 402 over time.

FIG. 4 illustrates a scenario in which the voltage 410 across the input terminals (i.e., an input voltage) is initially, at a zeroth point in time tₒ, zero or negligible.

Initially, both the second and third LED sets are bypassed by their respective switch arrangements, and the first LED set is controlled to conduct power 420 (supplied by the energy charge storage device).

As the voltage at the input terminals rises, it reaches a first voltage threshold T₁ (and subsequently rises thereafter) at a first point in time t₁. The first voltage threshold T₁ occurs at a time when the voltage provided at the input terminals is sufficient to drive only one of the second 202 and third 203 LED sets, but not both, e.g., is below a forward voltage of the first, second and third LED sets.

At this point, one of the second and third LED sets is no longer bypassed, whilst the other is bypassed. Thus, the power 430 drawn by the second and/or third LED sets increases.

At this point, the current through the first LED set is also reduced such that the first LED set draws less power 420. In particular, the current through the first LED set may be reduced such that the combined power drawn by all LED sets in the tapped linear LED driver arrangement 300 remains constant or near constant. This maintains the level of overall light output by the LED driver arrangements.

It will be clear that the first point in time t₁ occurs when the amplitude of the input voltage reaches or rises above either the second threshold or third threshold (dependent upon which one is smaller). At this point, one of the second and third LED sets is no longer bypassed, i.e., is permitted to conduct current.

It also will be clear that the first point in time t₁ occurs when the amplitude of the input voltage reaches or rises above the fourth threshold. At this point, the current drawn by the first LED set is reduced.

In the illustrated scenario, the fourth threshold is equal to either the second threshold or the third threshold. This facilitates improved ease of control.

However, this is not essential. For instance, the fourth threshold may be larger than one of the second or third thresholds (but not the other) to allow the first LED set to maintain its power draw for a non-zero period of time after one of the second and third LED sets is no longer bypassed. This can avoid or reduce any sudden drops in light output by the LED driver arrangement 300.

As the voltage of the input terminals continues to rise, it will then reach a second voltage threshold T₂ at a second point in time t₂. The second voltage threshold T₂ occurs at a time when the voltage provided at the input terminals is sufficient to drive both the second 202 and third 203 LED sets, i.e., is above a forward voltage of the first, second and third LED sets.

At this point, neither the second LED set nor the third LED set is bypassed. Thus, the power 430 drawn by the second and/or third LED sets increases.

At this point, the current through the first LED set is also further reduced such that the first LED set draws less power 420. In particular, the current through the first LED set may be reduced such that the combined power drawn by all LED sets in the tapped linear LED driver arrangement 300 remains constant or near constant. This maintains the level of overall light output by the LED driver arrangements.

It will be clear that the second point in time t₁ occurs when the amplitude of the input voltage reaches or rises above both the second threshold and the third threshold. At this point, neither of the second and third LED sets are no longer bypassed, i.e., both LED sets are permitted to conduct current.

It will be clear that the second point in time t₂ occurs when the amplitude of the input voltage reaches or rises above the first threshold. At this point, the current drawn by the first LED set is reduced, e.g., to zero or a negligible value.

In the illustrated scenario, the first threshold is equal to the larger of the second threshold or the third threshold. This facilitates improved ease of control.

However, this is not essential. For instance, the fourth threshold may be larger than either one of the second or third thresholds to allow the first LED set to maintain its power draw for a non-zero period of time after both the second and third LED sets are no longer bypassed. This can avoid or reduce any sudden drops in light output by the LED driver arrangement 300.

The same process happens in reverse as the power 410 at the input terminals falls.

In particular, the voltage 410 provided to the input terminals (i.e., an input voltage) falls again to the second voltage threshold T₂ at a third point in time t₃. At this point, one of the second and third LED sets is bypassed, which allows the other LED set to continue to conduct power and emit light. Thus, the power drawn by the second or third LED sets is reduced. To counterbalance the reduction in light emission, the current through the first LED set is increased.

The voltage 410 provided to the input terminals (i.e., an input voltage) then falls again to the first voltage threshold T₁ at a fourth point in time t₄. At this point, both the second and third LED sets is bypassed. To counterbalance the resultant reduction in light emission by the second and third LED sets, the current through the first LED set is again increased.

Throughout this procedure, the current through the LED sets may be effectively controlled such that the total light output by the arrangement 300 is held to be effectively constant.

This technique helps to avoid or reduce the perception of a pulsating light output by the arrangement.

More particularly, the current through the first LED set may be controlled so as to draw a power equal to the total average power (at the input terminals) minus the (predicted) instantaneous power drawn by the second and third LED sets. This can achieve a constant or near-constant light output by the overall arrangement.

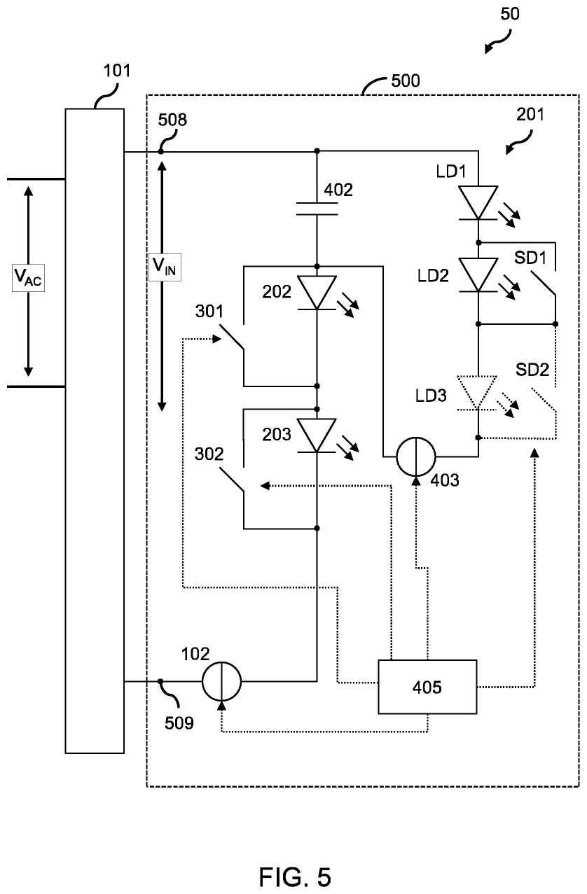

FIG. 5 illustrates a further example of an LED driving system 50, comprising another example of a tapped linear LED driving arrangement 500. In this example, the first LED set 201 is effectively configured to comprise another tapped linear LED driver arrangement, i.e., a subordinate tapped linear LED driver arrangement.

In this way, the first LED set 2011 comprises a first LED LD1 and at least one second LED LD2, LD3 connected in series. The first LED set further comprises, for each second LED, an LED bypass arrangement SD1, SD2 connected in parallel to its respective second LED.

Thus, each LED bypass arrangement SD1, SD2 is connected in parallel to a respective second LED LD2, LD3 of the first LED set.

Each LED bypass arrangement is configured to responsive to the amplitude of a voltage across the first LED or the voltage across the charge storage device falling below a respective LED threshold, bypass the respective second LED to thereby prevent the respective second LED conducting current.

Each LED bypass arrangement is also configured to, responsive to the amplitude of a voltage across the first LED or the voltage across the charge storage device rising above the respective LED threshold, prevent bypassing of the respective second LED to thereby allow the second LED to conduct current.

The respective LED threshold for each LED bypass arrangement is different. In particular, for each LED threshold, the minimum difference to any other LED threshold is preferably equal to a forward voltage of an LED.

Thus, the LED driving system 50 effectively operates with a nested TLD i.e., provides an additional TLD that allows further voltage swing across the charge storage device.

Above described and illustrated examples make use of a plurality of LED modules, of which one is connected in parallel to a charge storage device. Although illustrated examples only illustrate up to three LED modules, the skilled person will appreciate that the principles herein outlined can apply to tapped linear LED driver arrangements having more than three LED modules connected in series.

Such arrangements comprise a first LED module and at least one other LED modules.

Each other LED module (apart from the first LED module) may comprise a respective LED set connected in parallel to a respective switch arrangement. Each of these LED modules is also associated with a respective, different threshold. For each LED module, the switch arrangement is configured to bypass the LED set when the input voltage falls below the respective threshold. The value of each threshold may represent a summation of the forward voltage(s) of different numbers of the LED sets. This represents the standard operation of a tapped linear LED driver arrangement.

The first LED module is connected in parallel to a charge storage device and comprises a first LED set and a current controller. The current controller is configured to control the current through the first LED set to compensate for any reduction in the power drawn by the other LED sets (resulting from input voltage reducing), to thereby maintain an output light level.

In some variants to any above disclosed system, the driver arrangement further comprises an additional switch arrangement configured to controllably bypass the first LED module (and therefore the charge storage device as well). This facilitates flexibility in changing the conduction order of the LED modules, if desired, and can be used to control the total harmonic distortion of the driver arrangement, e.g., using a switched-mode power supply mechanism.

In such embodiments, to prevent charge stored at the charge storage device dissipating, the driving arrangement may comprise a diode connected between the additional switch arrangement and the charge storage device, e.g., between the first input terminal and the charge storage device.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A tapped linear LED driver arrangement comprising:
a first input terminal and a second input terminal for receiving an input voltage from an external power supply;
a first LED module comprising a first LED set, comprising one or more LEDs connected in series, and a first current controller connected in series to the first LED set;
a second LED module connected in series with the first LED module and comprising a second LED set, comprising one or more LEDs connected in series, and a first switch arrangement connected in parallel to the second LED set; and
a charge storage device connected in parallel to the first LED module, wherein:
the first LED module and the second LED module are connected in series between the first and second input terminals;
the first current controller is configured to:
responsive to the amplitude of the input voltage rising above a first threshold, reduce or prevent a current flow through the first LED set such that current, from the input terminal, flows through the charge storage device to the second LED module; and
responsive to the amplitude of the input voltage falling below the first threshold, increase a current flow through the first LED set such that current flows from the charge storage device through the first LED set, and
the first switch arrangement is configured to:
responsive to the amplitude of the input voltage falling below a second threshold, bypass the second LED set to thereby prevent the second LED set conducting current; and
responsive to the amplitude of the input voltage rising above the second threshold, prevent bypassing of the second LED set to thereby permit the second LED set to conduct current,
wherein the first current source controller is configured to control the maximum current flow through the first LED set when it conducts current, such that it emits a same or nearly the same amount of light as emitted by the second LED set when it conducts current.

2. The tapped linear LED drive arrangement of claim 1, wherein the second threshold is less than or equal to the first threshold.

3. The tapped linear LED drive arrangement of claim 1, wherein the second threshold is equal to the sum of the forward voltage of the first LED set and the forward voltage of the second LED set.

4. The tapped linear LED drive arrangement of claim 1, wherein the first current controller comprises a controllable current source.

5. The tapped linear LED drive arrangement of claim 1, further comprising a controller configured to control the operation of the first current controller and the first switch arrangement.

6. The tapped linear LED drive arrangement of claim 1, wherein:
the first LED set comprises a first LED and a second LED connected in series;
the first LED module comprises an LED bypass arrangement connected in parallel to the second LED, the LED bypass arrangement being configured to:
responsive to the amplitude of a voltage across the first LED or the voltage across the charge storage device falling below a first LED threshold, bypass the second LED to thereby prevent the second LED conducting current; and
responsive to the amplitude of a voltage across the first LED or the voltage across the charge storage device rising above the first LED threshold, prevent bypassing of the second LED to thereby allow the second LED to conduct current.

7. The tapped linear LED drive arrangement of claim 1, further comprising a second current source controller connected in series with the second LED module for controlling a maximum current flow through the first and second LED modules.

8. The tapped linear LED driver arrangement of claim 1, further comprising a third LED module connected in series with the second LED module and comprising:
a third LED set comprising one or more LEDs connected in series; and
a second switch arrangement connected in parallel to the third LED set, the second switch arrangement being configured to:
responsive to the amplitude of the input voltage falling below a third threshold, bypass the third LED set to thereby prevent the third LED set conducting current; and
responsive to the amplitude of the input voltage rising above the third threshold, prevent bypassing of the third LED set to thereby permit the third LED set to conduct current,
wherein the third threshold is different to the second threshold.

9. The tapped linear LED drive arrangement of claim 8, wherein:
the first current controller is configured to:
responsive to the amplitude of the input voltage falling below a fourth threshold, increase a current flow through the first LED set;
responsive to the amplitude of the input rising above the fourth threshold, reduce the current flow through the first LED set,
the fourth threshold is less than the first threshold; and
the first current controller is further configured such that the current flow through the first LED set is greater when the amplitude of the input voltage is between the fourth threshold and the first threshold than when the amplitude of the input voltage is above the first threshold.

10. The tapped linear LED drive arrangement of claim 9, wherein the fourth threshold is greater than or equal to the third threshold.

11. An LED driving system comprising:
the tapped linear LED drive arrangement of claim 1; and
a rectifier, connected to the first and second input terminals, configured to rectify a mains power supply to produce the input voltage for the first and second input terminals.
